(19) United States
(12) Patent Application Publication
(10) Pub. No.: US 2023/0248608 A1
(43) Pub. Date: Aug. 10, 2023

(54) DEVICE FOR THE TREATMENT OF HYDROCEPHALUS

(71) Applicants: Università Cattolica del Sacro Cuore, Milano (IT); Fondazione Policlinico Universitario Agostino Gemelli IRCCS, Rome (IT)

(72) Inventors: Carmelo ANILE, Rome (IT); Fabio NEBBIA, Casale Monferrato (IT)

(21) Appl. No.: 18/002,968

(22) PCT Filed: Jun. 23, 2021
(86) PCT No.: PCT/IB2021/055544

§ 371 Date: Dec. 22, 2022

(30) Foreign Application Priority Data
Jun. 25, 2020 (IT) 102020000015256

(51) Int. Cl. A61H 23/00

(52) U.S. Cl. CPC A61H 23/006; A61H 2201/1207; A61H 2201/165; A61H 2201/5005; A61H 2230/065; A61H 2201/1611

(57) ABSTRACT

The present invention relates to a device (100) wearable at a user's neck, which device (100) comprises:—a main body (10) provided with movable pushing means (11),—a control unit (20) configured to receive as input data associated with the user's heart rate and to generate a corresponding output signal (20′), wherein said output signal (20) determines a pulsating movement of said pushing means (11) according to the heart rate and wherein said pushing means (11) is positioned so as to compress and decompress the neck at the jugular veins.

### TECHNICAL FIELD OF THE INVENTION

The present invention relates to the field of the medical devices. The present invention, in particular, relates to a device wearable for the not invasive treatment of hydrocephalus.

### BACKGROUND

Hydrocephalus is a pathology “visually” characterized by an abnormal increase in the volume of the ventricular space (and, vice versa, by a decrease in the interstitial space) more or less associated to a framework of endocranial hypertension or to a syndrome characterized by “gait disorders”, “cognitive deficits” and “sphincter incontinence”, also known as “Hakim and Adams's Triad”.

In the context of the studies and of the treatments of such pathology, one of the most recent hypotheses associates the causes of hydrocephalus mainly to two aspects correlated to each other: the liquoral (CSF) pulsation, associated to the heart rate, and the “asymmetrical” behaviour of the venous blood outgoing from cranium, thereupon the capability of the intracranial system of compensating the variations in the intracranial volume and, then, in the CSF pulsation depends.

With reference to a pulsating, rhythmic event, such as cyclic pulsation of cerebral arteries, such asymmetry results to be bound to the heart activity and it is transferred, by means of CSF, to the so-called brain “bridging veins” (“bridge-like” veins) in the distal portion at the inlet to the upper sagittal sinus.

The intracranial system, that is the set constituted by a container (cranium and dura mater) and content (brain parenchyma), behaves not symmetrically with respect to the above-mentioned pulsation, which is distinguished in systolic phase and diastolic phase. In other terms, the behaviour is different (that is, asymmetrical) during systole (that is when the pulsative wave reaches cranium) with respect to diastole (that is in the releasing phase after systole).

In an “ideal” situation of symmetrical behaviour, there would be the same relative behaviour of pressures and of resistance offered by vessels and then, of the flows between systole and diastole.

However, in a “real” situation an asymmetrical behaviour of the intracranial system is observed as the resistance to the circulation of fluids in fact is determined by a system of resistances variable with the shape of the ducts. In this sense, higher resistance values and then lower flows correspond to high pressure values during systole, whereas lower resistances and then higher flows correspond to low pressure values during diastole.

As mentioned previously, such behaviour is mainly conditioned by the shape assumed by the bridging veins in their portion entering the upper sagittal sinus (so-called “Starling Resistor”).

During systole, the throttled shape which such vessels assume produces more resistance to the venous outflow than it decreases during the diastolic phase. In this way the production of the interstitial fluid decreases during systole, whereas the absorption of the latter remains unaltered during the diastolic phase, thus inducing, conversely, the formation of hydrocephalus.

In literature different new approaches for the treatment of such pathology are known, which avail of prosthetic, invasive and implantable systems, aimed at decreasing the CSF pulsating pressure.

In some cases, such decrease is obtained by subtracting and infusing a certain amount of cerebrospinal fluid, in other cases by expanding and contracting a pre-established volume of a suitably selected fluid, not directly in contact with cerebrospinal fluid.

Other known solutions provide the insertion of a small balloon in the jugular veins, configured so as to be “inflated” and to generate an overpressure equal and contrary to the one of the outgoing blood, so as to “re-open” the Starling resistors placed at the entrance of the “bridge-like” cerebral veins and to restore the interrupted vein flow.

A disadvantage of this solution lies in the fact that by inflating a small balloon inside the jugular veins, the brain blood flow is however blocked, as it happened already for the pathological mechanism of the brain “tamponage” thereto such solution was intended to give an answer.

US 2019/262212 A1, for example, discloses a wearable device and a method to assist the movement of the body biofluids of a patient through stimulating mechanisms configured to assist the flow of said biofluids. US 2013/317580 A1 discloses a device and a method for treating neurological pathologies such as ictus, by administering electrical and/or electromagnetic pulses supplied in a not invasive way for the patient.

Moreover, the need is generally felt to provide solutions which are suitable to not invasive approaches and which allow to treat effectively such pathology even without the need of hospitalizing the patient.

### BRIEF DESCRIPTION OF THE INVENTION

The technical problem placed and solved by the present invention is then to overcome the above-illustrated problems and, in particular, to provide a device for the not invasive treatment of hydrocephalus.

This is obtained through a device as defined in claim 1.

Additional features of the present invention are defined in the corresponding depending claims.

In a preferred embodiment, the invention provides a device wearable at the neck of a user, comprising a main body provided with movable pushing means and a control unit. The control unit is configured to receive, as input, data associated with the user's heart rate and to generate a corresponding output signal which determines a pulsating movement of the pushing means according to the heart rate. Said pushing means is positioned so as to compress and decompress the neck at the jugular veins.

It will be appreciated that the principle underlying the present invention is to treat hydrocephalus by acting on the blood flow with the purpose of modifying its mode for outgoing from the cranium, by administering a “counter-pulsation” which indirectly adjusts the natural pathological CSF pulsation.

The invention proposes, i.e., to modify the effects of the intracranial pulsation through a percutaneous compression and decompression action, an external, suitably rhythmic and cyclic action, applied at the jugular veins at the neck.

The jugular veins are in direct communication with the upper sagittal sinus, that is the venous structure which represents the exhaust manifold of the cerebral veins. The device of the invention, by explicating its action on the distal portion of the cerebral veins (the so-called Stirling resistor) through an indirect compression and decompression of such structures, advantageously allows to modify the so-called intracranial “pulsation” linked to the dilation of the cerebral arteries.

In this sense, advantageously, the device of the invention generates a “counter-pulsation” of the bridge-like cerebral veins (Starling resistor) which not only determines a “static” pulsatile wave, thus annulling the effects of the intracranial pulsation on the formation of hydrocephalus, but it even reduces the asymmetry effect determined by the Starling resistor.

The control unit of the wearable device of the invention is preferably configured to generate the output signal associated to the movement of the pushing means, with a predetermined phase shift with respect to the frequency of the heart rate.

The administration of a rhythmic “counter-pulsation” on the cardiac cycle through the pulsating movement of the pushing means which compress and decompress the jugular veins with a specific offset with respect to the cardiac cycle itself, allows to determine a shape variation of the Starling resistor so as to annul the “asymmetric” effect originating hydrocephalus.

Advantageously, the invention allows to simplify the protocols and the medical procedures for the treatment of hydrocephalus, by providing a compact device wearable on the user's neck, which acts in a wholly not invasive way, to the whole advantage both of patient and of the healthcare professionals.

Other advantages, together with the features and use modes of the present invention, will result evident from the following detailed description of preferred embodiments thereof, shown by way of example and not with limitative purposes.

### BRIEF DESCRIPTION OF FIGURES

The drawings shown in the enclosed figures will be referred to, wherein:

FIG. 1 shows a schematic view of the device according to a preferred embodiment of the present invention;

FIG. 2 shows a first embodiment of the device according to the present invention;

FIG. 3A shows a block diagram of the operating connections between the components of the device of the invention according to a preferred embodiment;

FIG. 3B shows a flow diagram of a preferred embodiment of the operating logic of the device of the invention;

FIG. 4 shows the representation on a Cartesian plane of the profile of a preferred embodiment of a single pulse of the output signal obtainable with the device of the invention;

FIG. 5 shows the correlation between the profile of the output signal of FIG. 4 and the piece of data entering the control unit of the device of the invention, in particular an ECG signal, represented on respective Cartesian planes;

FIG. 6 shows the variability of the profile of the output signal of FIG. 5 with respect to the variability of the ECG signal, represented on respective Cartesian planes;

FIG. 7 shows a second embodiment of the device according to the present invention.

### DETAILED DESCRIPTION OF EMBODIMENTS OF THE INVENTION

The present invention will be described hereinafter by making reference to the above-mentioned Figures.

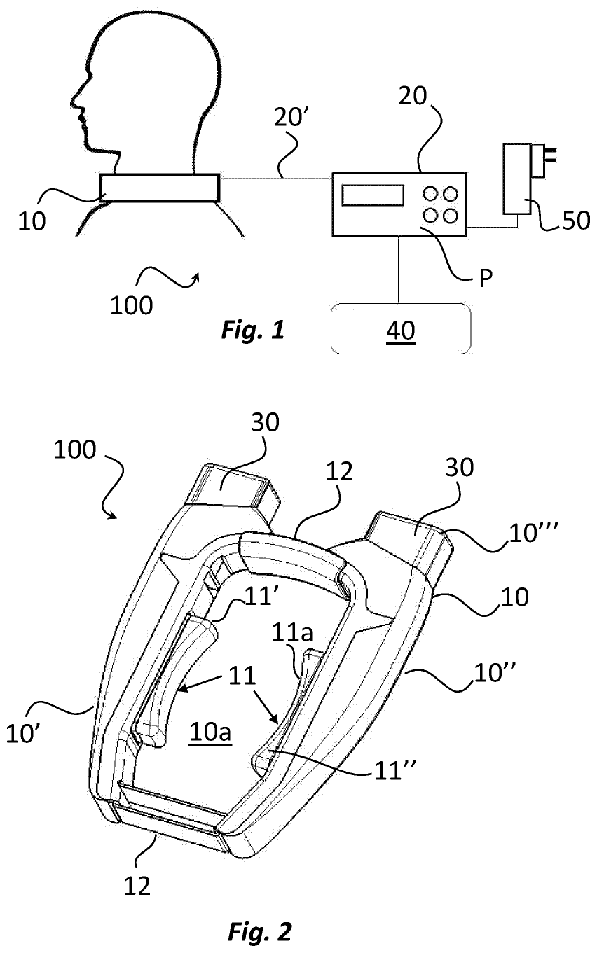

By firstly referring to FIG. 1 a schematic view of the wearable device, the invention relates to, is illustrated, designated as a whole with the reference 100. The components constituting it are illustrated separately for ease of viewing.

By further referring to FIG. 2, in the preferred embodiment the device 100 is in the form of a collar wearable around a user's neck and, as it will be illustrated hereinafter, it is specifically configured for the not invasive treatment of hydrocephalus.

In general terms, the device 100 comprises a main body 10 provided with movable pushing means 11 and a control unit 20. Under worn condition, the device 100, in particular the main body 10, is preferably shaped so as to rest upon the user's shoulders and/or bust.

The device 100 further comprises means for energy supply, for example integrated in the main body 10, for the operation of the above-mentioned components. In some variants it can include a power supply with rechargeable batteries, so as to provide autonomy to the device 100 and make it wholly portable. Said supply means, alternatively, can include a transformer 50, as schematically illustrated in the example of FIG. 1, for a connection to the low mains voltage.

The pushing means 11 are movable between a rest condition and an activation condition. In said activation condition, the pushing means 11 is configured to provide a compression and decompression in the region of the user's neck, in particular at the jugular veins.

The control unit 20 is configured to receive, as input, data associated with the user's heart rate and to generate a corresponding output signal 20′ so as to determine a pulsating movement of the pushing means 11 according to the heart rate.

By specifically referring to FIG. 2, a first embodiment variant of the main body 10 of the device 1 according to the invention can be seen.

According to such first variant, the main body 10 comprises a first 10′ and a second 10″ frame element connected to each other by means 12 for adjusting the positioning of the device 100 around the user's neck.

Generally, the overall shape of the main body 10 is annular to surround the user's neck. Such main body 10 defines an internal region 10a suitable indeed to receive the neck. In this first variant, the adjusting means 12 allows to modify the shape of the main body 10 to vary the width of said internal region 10a.

In the example illustrated in FIG. 2, it can be seen that each frame element 10′, 10″ is shaped like an “arm” and, under condition of device 100 worn by the user, it develops substantially on the opposite sides of the neck with respect to the sagittal plane.

The frame elements 10′, 10″ can be adjusted by mutually approaching and/or moving away, to allow to insert and suitably wear the device 1 on necks having different sizes.

The adjusting means 12 further allows to select the suitable position of the pushing means 11 with respect to the user's neck, when the latter is in the above-mentioned rest condition. Preferably, in said rest condition, the pushing means 11 is not in contact with the user's neck.

According to a preferred embodiment, the pushing means 11 comprises pistons which, under activation condition, are movable between a retracted position and an extracted position with respect to the main body 10.

In extracted position, the pushing means 11 is in contact with the neck, by compressing it at the jugular veins.

In retracted position, however, the pushing means 11 can be in contact with the neck but by performing on the latter a lower compression amount with respect to when it is in extracted position.

In a preferred embodiment, the pushing means 11 further comprises a surface 11a in contact with the user's neck which has a concave profile so as to follow the natural bending of the neck at the jugular veins.

Preferably, the device 1 comprises pushing means 11 on both sides of the neck and, in the variant of FIG. 2, each frame element 10′, 10″ comprises respective pushing means 11′, 11″. The movement of the pushing means 11 is preferably synchronous.

In an embodiment, the above-mentioned adjusting means 12 constrains to each other corresponding opposite ends of the frame elements 10′, 10″. The adjusting means 12 for example can include a telescopic coupling of guides/rails or Velcro®. The adjusting means 12 can further be provided with deformable elements to make comfortable the contact of the rear portion of the neck and/or, frontally, of the throat with the main body 10.

The main body 10, in particular each frame element 10′, 10″ in the example illustrated in FIG. 2, is preferably made of plastic, hypoallergic material, for use in healthcare field. It has lightness features.

The main body 10, preferably inside thereof, further has motor means 30 for actuating the pushing means 11. Preferably, the motor means 30 is positioned in a front portion 10″′ of the main body 10, or at the user's bust under condition of worn device 100.

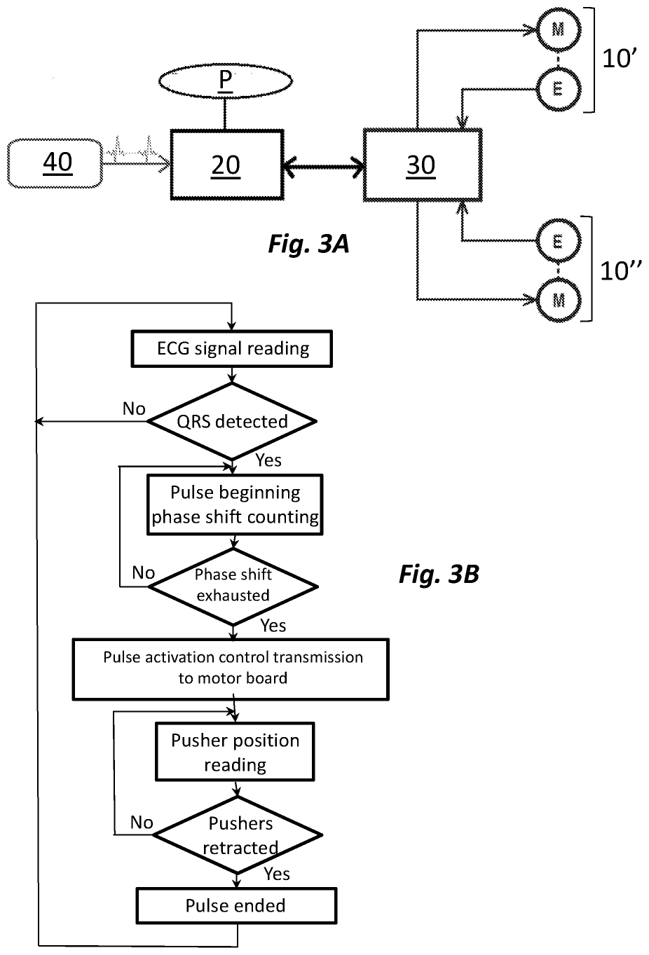

By referring to FIG. 3A, the motor means 30 is controlled by the control unit 20 and, by further referring to the first variant of the device 1 described above and illustrated in FIG. 2, comprises stepper-type motors (designated with the letter M), preferably a stepper motor for each frame element 10′, 10″.

Generally, the motor means 30 can be provided with encoder (E) for controlling in real time the position of the pushing means 11 and, for this reason, it can be configured for a bidirectional communication with the control unit 20.

During use of the device 100, advantageously, the control unit 20 constantly acquires the position data of the pushing means 11, preferably both under their activation and rest condition. For example, the control unit 20 is configured to transform the acquired position data into an electric signal which can be displayed on a display of the device 100. In this way an operator can check the time course of the pulsating movement of the pushing means 11.

Advantageously, the presence of the encoders (E) further allows to bring the pushing means 11 back in the correct position when it is under rest condition, for example at the end of each operating cycle. In this way it is possible to compensate mechanical or shelling tolerances of the motor means 30 which, otherwise, could cause the accumulation of a positioning error so as to determine a misalignment of the pushing means 11 and to invalidate the correct operation of the device 100.

The control unit 20 is further configured to be operatively connected to detection means 40 of a biophysical parameter of the user. In embodiments, the device 100 can integrate said detection means 40.

The detection means 40 preferably comprises one or more sensors suitable to provide as input to the control unit 20 a signal associated to the pulsation, or rhythm, of the cardiac cycle. Said input signal preferably is an electric signal and can relate, for example, to an ECG trace.

In embodiment variants, the main body 10 can integrate the pushing means 11 and the control unit 20 and, preferably, further comprise the detection means 40.

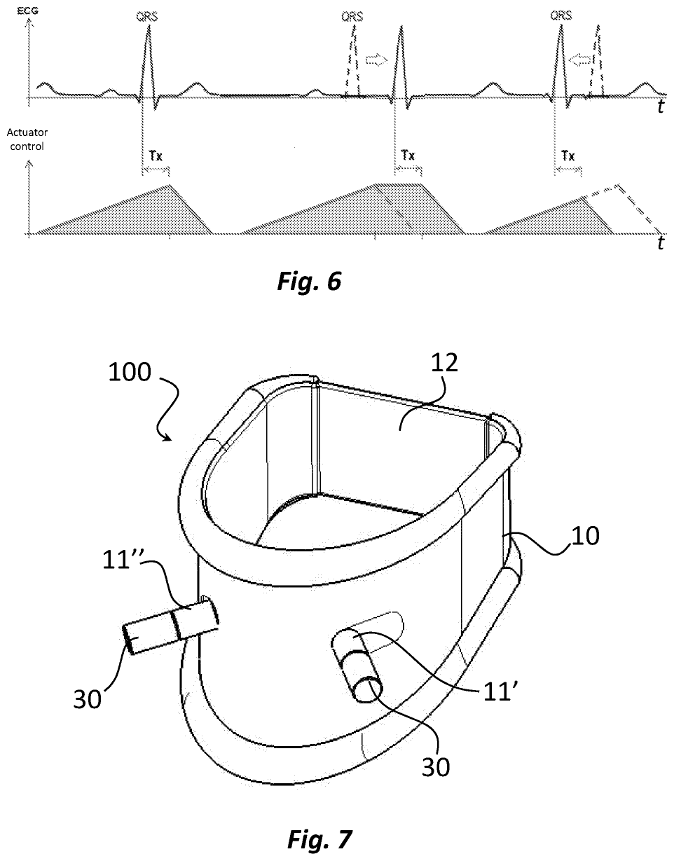

By way of example, an alternative embodiment of the device 100 of the invention is described hereinafter with reference to FIG. 6.

In such variant, the main body 10 comprises a flexible plastic collar implemented in one single frame element surrounding the user's neck. Adjusting means 12, for example Velcro®, can be placed in a rear region of the main body 10 to allow the correct positioning of the device 100 and the reversible closing around the neck.

The motor means 30 is coupled to the pushing means 11′, 11″ and can include two solenoid actuators, for example powered at low voltage. The motor means 30 preferably is assembled on supports which are movable on the main body 10 along the neck's circumference. In this way it is possible to adjust suitably the position of the pushing means 11′, 11″ at the jugular veins.

Going back to FIG. 3A and according to a preferred embodiment, the control unit 20 is configured to allow an operator to select operating parameters of the device 100. To this purpose, the control unit comprises control means P therethrough it is possible to set said parameters. The control means P can include the same above-mentioned display or a dedicated interface.

For example, it is possible to set parameters related to the pulsating movement of the pushing means 11, for example moving speed and/or depth and/or mode for synchronizing with the data received by the detection means 40.

In this sense, the output signal 20′ from the control unit 20 which controls the movement of the pushing means 11 can be not only function of the data received as input by the control unit 20 itself, but, advantageously, even programmable by an operator and/or user.

As mentioned previously, the control unit 20 then acquires as input data associated with the user's heart rate, for example a signal of an electrocardiograph, and it generates a corresponding output signal 20′ which determines a movement of the pushing means 11 with selected features. At a selected initial instant T₀, the output signal 20′ sent by the control unit 20 then controls the motor means 30, to bring the pushing means 11 under activation condition with a pulsating movement according to the heart rate.

Preferably, the control unit 20 is further configured to control the absorbed current and the temperature of the motor means 30. In this way advantageously it is possible to perform compensations if, after a continuing use of the device 100, a temperature increase should lead to a decrease in the provided torque with consequent deterioration of the compression/decompression force applied with the pushing means 11. In some embodiment variants and within predetermined threshold values, the operating parameters of the motor means 30 can be set through the control unit 20 and/or the control means P.

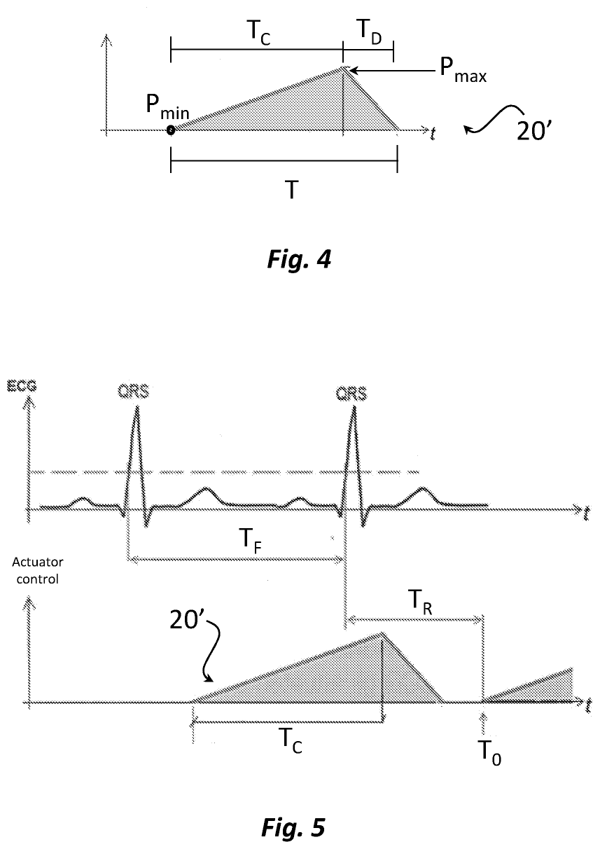

By referring to FIGS. 4 and 5, a preferred embodiment of the profile of the output signal 20′ generated by the control unit 20 is shown, with reference to the data entering the latter. Said output signal 20′ comprises a periodic wave form and preferably with triangular profile. FIG. 4 illustrates a single pulse of said output signal 20′. The profile of the wave form of the output signal 20′ can even be trapezoidal, as it will be described more in details hereinafter.

The particular profile of the output signal 20′ generated by the device 100 of the invention is based upon the following considerations.

The wave form of the intracranial pressure, the so-called “CSF pulsation wave”, associated to the corresponding blood, in particular intraventricular, pressure wave, has features varying depending upon the fact that the subject is or is not affected by hydrocephalus.

In a patient with such pathology, the CSF pulsation wave has a shape that, represented on a Cartesian plane depending upon the heart rate time, follows substantially the wave form of a triangle, typically a scalene triangle. The longest side of said scalene triangle lies on the time axis, the shortest side represents the beginning of the pulsation (the systole) and the intermediate side represents the moment in which the heart push has exhausted and the system starts to rest (diastole).

According to the invention, the output signal 20′ generated by the device 100 then represents a “counter-pulsation” of the bridge-like cerebral veins (Starling resistor) with respect to the CSF pulsation wave.

Advantageously, the action of such counter-pulsation is obtained by generating the specific output signal 20′ which, preferably, has a combination of three features: 1) it is calibrated on each single heartbeat 2) it has a constant and predetermined phase shift with respect to the beginning of the single beat thereto it refers and, still more preferably, 3) it has a triangular wave form, or however, analogous to the wave form of the CSF pulsation which it has to contrast. In this last case, and differently from the wave form of the CSF pulsation, the longest side of the output signal 20′ represents an initial phase of the “counter-pulsation”, or a condition of growing pressure, whereas the shortest side of the output signal 20′ represents a final phase of the “counter-pulsation”, that is a condition of decreasing pressure.

In other words, it will be appreciated that the device 100 of the invention allows to modify the effects of the intracranial pulsation through an external, suitably rhythmic and cyclic percutaneous compression and decompression action, applied at the jugular veins at the neck.

The control unit 20 is configured to acquire, preferably in real time, the data associated with the heart rate of the user who wears the device 100 and to generate the above-mentioned corresponding output signal 20′ based upon the acquired data.

FIG. 4 represents on a Cartesian plane, the profile of a single pulse of the output signal 20′ according to a preferred embodiment. Such profile corresponds to the compression and decompression movement of the pushing means 11 in time t. Said movement is comprised between a final position of maximum excursion Pₘₐₓ (corresponding to the maximum compression) and a final position of minimum excursion Pₘᵢₙ (corresponding to the minimum compression or decompression) of the pushing means 11 under the above-mentioned activation condition.

As it can be seen, each pulse of the output signal comprises a first compression time T_{C} and a second decompression time T_{D}. The compression time T_{C} and the decompression time To are consecutive to each other and form the period, or duration, T of the single pulse. Preferably, said compression time T_{C} is greater than said decompression time T_{D}. Once the compression time T_{C} has elapsed, the pushing means 11 is in the position of maximum excursion Pₘₐₓ.

The correlation between the profile of the output signal 20′ of FIG. 4 and the piece of data entering the control unit 20 of the device 100, in particular an ECG signal, is shown in FIG. 5 through a representation on respective Cartesian planes.

The output signal 20′ comprises a pulse which can be associated to a single heartbeat and, advantageously, it is a signal of periodical type and it comprises a plurality of pulses, wherein each pulse of the output signal 20′ can be associated to a corresponding heartbeat. Preferably a pulse of the output signal 20′ has a lower duration T than time T_{F} elapsing between two consecutive heartbeats. In the illustrated example, the latter refers to the time elapsing between two consecutive QRS.

The maximum excursion Pₘₐₓ of the pushing means 11 can be a programmable parameter of the control unit 20. For example, the maximum excursion Pₘₐₓ can include the maximum advancing expressed in millimetres (mm) of the pushing means 11 with respect to their rest condition or retracted position (if the pushing means is under activation condition).

As it can be seen, the output signal 20′ advantageously has a predetermined phase shift T_{R}, preferably comprised between 300 and 400 milliseconds. Advantageously, said predetermined phase shift T_{R} is constant (for each considered subject) with respect to the frequency of the heart rate. The phase shift of the trigger instant T₀ of the output signal 20′ with respect to the instant wherein the corresponding pulsation, or rhythm, heartbeat starts, can be a parameter which can be set in the control unit 20.

Therefore, said “counter-pulsation” obtained through the pushing means 11 not only determines a pulsatile wave which neutralizes the effects of the intracranial pulsation on the formation of hydrocephalus, but it reduces even the asymmetry effect determined by the Starling resistor, as it is calibrated on the single heartbeat.

By referring to FIG. 3B, a flow graph is illustrated exemplifying a preferred use mode of the device 100, in particular of the operation logic of the control unit 20.

The control unit 20 receives as input an ECG signal and, in case it detects a QRS value, it processes the predetermined phase shift T_{R} therewith a first pulse of the output signal 20′ has to be generated. Once such phase shift has elapsed, at the instant To the control unit 20 transmits the activation control to the motor means 30 which actuates the pushing means 11 according to a pulsating movement.

The control unit 20 monitors the position of the pushing means 11 during their movement. When the control unit 20 detects that the pushing means 11 is in retracted position, the duration T of said first pulse of the output signal 20′ has ended. Upon the detection of a subsequent QRS value, the control unit 20 processes again a predetermined phase shift, preferably the same predetermined phase shift calculated for the above-mentioned first pulse, by generating a second pulse which activates the motor means 30 at the instant T₀₊₁, with the purpose of actuating the pushing means 11 analogously to what described above for the preceding pulse.

In the example illustrated in FIG. 6 it can be seen that the control unit 20 can be configured to generate an output signal 20′ wherein the decompression time To is variable as a function of the time T_{F} elapsing between two consecutive heartbeats.

Advantageously, in this way it is possible to handle patients with cardiac arrhythmia (extrasystole, arrhythmia of various type) which, with respect to the normal cadence, determine for example some QRS (illustrated generically with Tₓ in the graph of FIG. 6) in advance or late. In case the beginning of the decompression phase To takes place with a certain phase shift Tₓ, the profile of the output signal 20′, as it can be seen, assumes a substantially trapezoidal wave form.

The control unit 20 then advantageously can be configured to follow the wave form of the signal which can be associated to the data entering it, by generating an output signal 20′ whose pulses comprise an increased (or decreased) compression time T_{C} with respect to the preceding (or subsequent) pulse as a function of a variability of the heart rate rhythm.

According to an additional aspect, the present invention relates to a method for treating hydrocephalus comprising the steps of:
providing a device wearable on a user's neck, the device comprising movable pushing means,
generating a pulsating movement of said pushing means at the jugular veins,

wherein the pulsating movement is generated according to the user's heart rate and, preferably, with a predetermined phase shift with respect to the frequency of its heartbeat.

The present invention has been so far described with reference to preferred embodiments thereof. It is to be meant that each one of the technical solutions implemented in the preferred embodiments, herein described by way of example, could advantageously be combined differently therebetween, to create other embodiments, belonging to the same inventive core and however all within the protective scope of the herebelow reported claims.

1. A device (100) wearable at the neck of a user for the treatment of hydrocephalus, which device (100) comprises:
a main body (10) provided with movable pushing means (11) positioned, in use, at the jugular veins,
a control unit (20) configured to receive as input data associated with the user's heart rate and to generate a corresponding output signal (20′),
wherein said output signal (20′) determines a pulsating movement of said pushing means (11) according to the heart rate and wherein said pushing means (11) is configured to compress and decompress the neck at the jugular veins.

2. The wearable device (100) according to claim 1, wherein said output signal (20′) comprises a pulse associable with a single heartbeat, wherein said pulse is generated in a trigger instant (T₀) with a predetermined phase shift (T_{R}) with respect to an initial instant of the corresponding heartbeat.

3. The wearable device (100) according to claim 1, wherein said output signal (20′) is periodic and comprises a plurality of pulses each one having duration (T) lower than time (T_{F}) elapsing between two consecutive heartbeats.

4. The wearable device (100) according to claim 1, wherein said output signal (20′) comprises a pulse with a triangular or trapezoidal profile.

5. The wearable device (100) according to claim 2, wherein the duration of said pulse comprises a first compression time (T_{C}) and a second decompression time (T_{D}), consecutive to each other, wherein said compression time (T_{C}) is greater than said decompression time (T_{D}).

6. The wearable device (100) according to claim 5, wherein said decompression time (T_{D}) is variable as a function of the time elapsing between two consecutive heartbeats.

7. The wearable device (100) according to claim 5, wherein a final position of maximum excursion (Pₘₐₓ) and a final position of minimum excursion (Pₘᵢₙ) of the pushing means (11) corresponds to said compression time (T_{C}) and to said decompression time (T_{D}), respectively.

8. The wearable device (100) according to claim 1, wherein said control unit (20) is configured to receive a real time ECG signal.

9. The wearable device (100) according to claim 1, wherein said pushing movement is obtained through actuation means (30) comprising stepper motors or solenoid actuators controlled by the control unit (20).

10. The wearable device (100) according to claim 1, further comprising means (12) for adjusting the position of the pushing means (11).

11. The kit comprising a device (100) according to claim 1 and means (40) for detecting the user's heart rate.
